(19) United States
(12) Patent Application Publication
(10) Pub. No.: US 2013/0090973 A1
(43) Pub. Date: Apr. 11, 2013

(54) Enterprise Interaction Management Methods and Apparatus

(71) Applicants: Shiu Hui, San Mateo, CA (US); Rabih Abou-Chakra, Chatenay-Malabry (FR)

(72) Inventors: Shiu Hui, San Mateo, CA (US); Rabih Abou-Chakra, Chatenay-Malabry (FR)

(21) Appl. No.: 13/269,499

(22) Filed: Oct. 7, 2011

(51) Int. Cl. G06Q 10/00

(52) U.S. Cl. 705/7.24; 705/1.1

(57) ABSTRACT

A system for managing interactions within an enterprise includes a network-connected server, and software executing on the server from a non-transitory physical medium, the software providing a first function for establishing a recorded instantiation of a reoccurring event and assigning a unique identifier to that event, a second function for creating an abstract conversation entity object representing the reoccurring event and for creating an executable conversation instance entity object to represent specific meetings or collaboration events under the reoccurring event, a third function for matching any incoming or outgoing interactions or interaction requests that materialize within the enterprise domain to the conversation instance entity tied to the conversation entity, and a fourth function for managing and archiving the interaction records and results thereof as searchable interaction records tied to the conversation instance entity.

### CROSS-REFERENCE TO RELATED DOCUMENTS

N/A

### BACKGROUND OF THE INVENTION

1. Field of the Invention

The present invention is in the field of information management in telephony and data communications and pertains particularly to methods and apparatus for tracking interactions and associating them with appropriate work processes ongoing within an enterprise environment.

2. Discussion of the State of the Art

In the field of information management as it pertains to telephony and data network communication, enterprise personnel such as project managers spend a large amount of time tracking and managing information. Information in the form of artifacts related to work projects are gathered and or created in meetings, phone calls, email exchanges and over other communication channels, which may involve multiple resources.

In current enterprise environments, work artifacts are stored in various data-storage repositories. These artifacts often do not have any associated references to the interaction event that spawned them. This condition causes a significant amount of work for project managers relative to finding and tracking work artifacts that are relevant to his or her project.

More recently, tools have been developed that address some parts of the problem stated, such as tracking formal project milestones and deliverables related to a work project, or facilitating enterprise-wide internal communication. However, many project-related artifacts may occur outside of the realm or domain of a project server. A challenge for enterprise management of information is providing readily accessible data about who worked on a project, when did various project activities take place, where did those activities take place and what were the results of those activities. Therefore, what is clearly needed are methods and apparatus for tracking and managing interactions and interaction results relative to an ongoing work project that solve the problems stated above.

### SUMMARY OF THE INVENTION

The problem stated above is that accountability is desirable for information management within an enterprise environment, but many of the conventional means for managing information, such as project management applications or sales team applications also create additional information management tasks that must be handled manually. The inventors therefore considered functional components of an information management system, looking for elements that exhibit interoperability that could potentially be harnessed to provide full tracking and management capability for project interactions and results but in a manner that would not more work.

Every enterprise information management system is characterized by monitoring, data gathering, and data sorting, one by-product of which is an abundance of project-related data made accessible to project participants. Most such systems employ servers running software applications to aid personnel in the management and use of such data, and servers running dedicated applications are typically a part of such apparatus.

The present inventor realized in an inventive moment that if, after the point of project establishment, subsequent interactions and associated outcome information could be identified, tracked, and associated with a specific parent project, significant reduction of information management work might result. The inventor therefore constructed a unique network-based system for managing project related interactions and results thereof that allowed interactions and results to be readily identified and associated automatically with ongoing enterprise work projects whether those artifacts occurred within the domain or external to the domain of the ongoing work project that spawned them. A significant reduction in information management tasks results, with no impediment to quality or work project progress created.

Accordingly, in an embodiment of the present invention, a system for managing interactions within an enterprise is provided and includes a network-connected server, and software executing on the server from a non-transitory physical medium, the software providing a first function for establishing a recorded instantiation of a reoccurring event and assigning a unique identifier to that event, a second function for creating an abstract conversation entity object representing the reoccurring event and for creating an executable conversation instance entity object to represent specific meetings or collaboration events under the reoccurring event, a third function for matching any incoming or outgoing interactions or interaction requests that materialize within the enterprise domain to the conversation instance entity tied to the conversation entity, and a fourth function for managing and archiving the interaction records and results thereof as searchable interaction records tied to the conversation instance entity.

In one embodiment, the network is one of a local area network or a wide area network connected to the Internet network. In one embodiment, the network is the Internet network. In one embodiment, the interactions include messages and message chains, voice interactions, video interactions, presentations, documents, and notes. In one embodiment, the reoccurring event is a physical meeting of live persons or a virtual meeting of live persons detected by virtual presence.

In one embodiment, the reoccurring event is generated by a calendar-based application. In a variation of this embodiment, the calendar-based application is a meeting and appointment scheduling application or a conference scheduling application. In another variation of the embodiment, the calendar-based application is a collaboration scheduling application.

In one embodiment, the conversation instance entity object is an attribute of the conversation entity object, the conversation instance entity object related to the conversation entity object by description including keywords and or a unique identifier. In a preferred embodiment, the interactions are identified as associated to a conversation entity instance object by matching description including keyword criteria. Also in a preferred embodiment, the interaction records are searchable via a search engine interface by entering keywords attributed to the conversation instance entity, the conversation entity, or the reoccurring event. In one embodiment, the conversation entity is assigned the same identification number as the reoccurring event and wherein the child conversation instance entities are assigned generated variants of the assigned identifier.

According to one aspect of the present invention, a method is provided for tracking and managing interactions and results thereof related to a reoccurring event generated within an enterprise domain comprising the steps (a) establishing a recorded instantiation of the reoccurring event and assigning a unique identifier to that event, (b) creating an abstract conversation entity object representing the reoccurring event and an executable conversation instance entity object to represent specific meetings or collaboration events scheduled under the reoccurring event, (c) matching any incoming or outgoing interactions or interaction requests that materialize within the enterprise domain to the conversation instance entity tied to the conversation entity, and (d) managing and archiving the interaction records and results thereof as searchable interaction records tied to the conversation instance entity.

In one aspect of the method, the interactions include messages and message chains, voice interactions, video interactions, presentations, documents, and notes. In one aspect, in step (a), the reoccurring event is a physical meeting of live persons or a virtual meeting of live persons detected by virtual presence. In one aspect the reoccurring event is generated by a calendar-based application. In a variation of this aspect, the calendar-based application is a meeting and appointment scheduling application or a conference scheduling application. In another variation of the aspect, the calendar-based application is a collaboration scheduling application.

In one aspect of the invention, in step (b), the conversation instance entity object is an attribute of the conversation entity object, the conversation instance entity object related to the conversation entity object by description including keywords and or a unique identifier. In one aspect, in step (c), the interactions are identified as associated to a conversation entity instance object by matching description including keyword criteria.

### BRIEF DESCRIPTION OF THE DRAWING FIGURES

FIG. 1 is an architectural view of an enterprise interaction management system according to an embodiment of the present invention.

FIG. 2 is a block diagram illustrating basic components of SW indicated in FIG. 1.

FIG. 3 is a process flow chart illustrating steps for creating a re-occurring event in object representation format according to an embodiment of the present invention.

FIG. 4 is a process flow chart illustrating steps for intercepting incoming or outgoing media events and matching those events with appropriate conversation entities according to an embodiment of the present invention.

FIG. 5 is a process flow chart illustrating steps for pulling interaction records for the purposes of matching them to an appropriate conversation entity according to an embodiment of the present invention.

### DETAILED DESCRIPTION

The inventors provide a system for managing interactions within an enterprise that enables automated aggregation and association of created work artifacts and communications that are relevant to an ongoing project characterized by a series of collaborative events, conferences, or meetings. The present invention is described in enabling detail using the following examples, which may describe more than one relevant embodiment falling within the scope of the present invention.

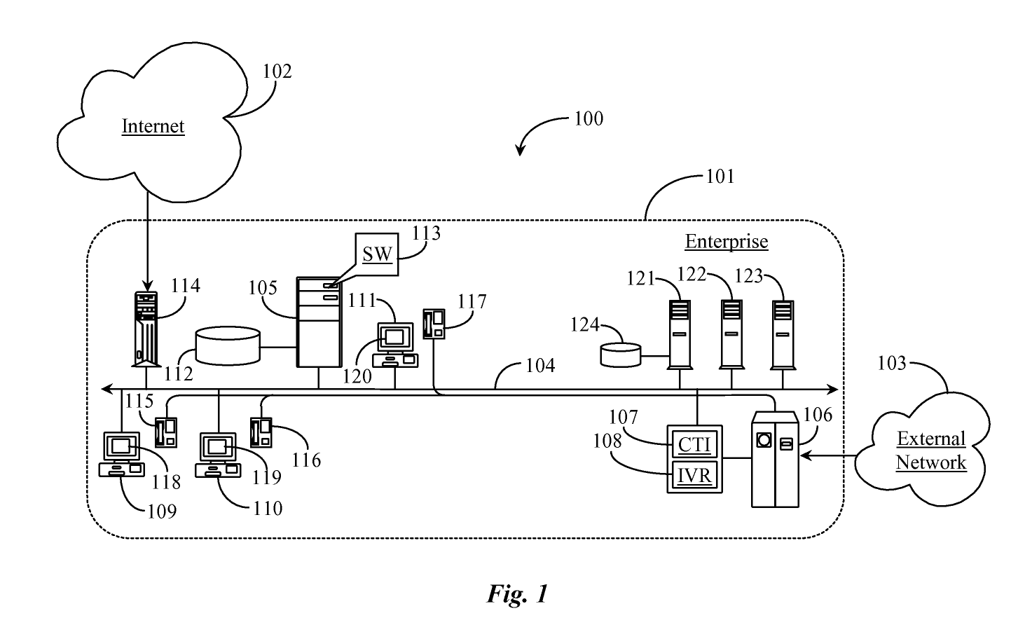

FIG. 1 is an architectural view of an enterprise interaction management network 100 according to an embodiment of the present invention. Network 100 includes a local area network (LAN) 104 within an enterprise domain 101, an Internet network 102, and an external communications network 103. Enterprise 101 may include onsite call center equipment or may contract with a third-party call center service. In this example, LAN 104 provides internal data communication within the enterprise domain. LAN 104 may be a corporate wide area network (WAN) or a campus area network (CAN) without departing from the spirit and scope of the present invention.

LAN 104 is enhanced with all of the protocols required to enable Internet access and service including transfer control protocol/Internet protocol (TCP/IP). LAN 104 is connected to Internet network 102 through a router 114. Router 114 has direct LAN connection. Router 114 is enhanced for Internet protocols (IP) and serves as the last hop for Internet-sourced data and voice communications coming into Enterprise domain 101. Router 114 may be intelligently programmed with specific routing routines provided for interaction and data event routing to various destination points on LAN 104.

Enterprise domain 101 includes a telephone switch 106, which may be an automated call distributor (ACD), a private branch exchange (PBX), or some other hardware or software telephony switch that is capable of routing interaction requests and connecting incoming, and internal telephony calls. Telephone switch 106 represents a last hop for incoming telephone calls destined for locations within the enterprise domain. Telephone switch 106 may also handle internal voice communication.

In this example, telephone switch 106 is enhanced with a computer telephony integrated (CTI) processor 107. CTI processor 107 is connected to switch 106 via a CTI trunk. CTI processor 107 provides routing intelligence to switch 106. Telephone switch 106 is also enhanced with an interactive voice response (IVR) unit 108 for intercepting and directing incoming telephone traffic sourced internally or from external network 103 or a like network. IVR 108 is directly connected to telephone switch 106 via CTI link. IVR 108 functions to intercept incoming calls and screen such calls to determine caller intent and to offer automated services.

LAN 104 supports multiple workstations operated by live persons within the enterprise. For example, a personal computer 109, a personal computer 110, and a personal computer 111 are illustrated in association with telephones 115, 116, and 117 respectively. Telephones 115, 116, and 117 are connected to telephone switch 106 by internal telephony wiring. External network 103 represents any external telephone carrier network, wired or wireless, that includes telephony switch 106 as a last destination for calls destined for enterprise 101. Personnel operating from the workstations may communicate externally or internally using telephones 115-117, and PCs 109-111.

LAN 104 supports multiple servers including an enterprise collaboration server 121, a calendar event server 122, and a messaging server 123. Messaging server 123 includes a non-transitory physical medium adapted to contain all of the data and software required to enable function as a messaging server. In this example, server 123 routes emails or other text messages, or both, internally over LAN 104. Emails may source from LAN connected nodes or from any external networks having access to LAN 104.

Calendar server 122 includes a non-transitory physical medium that contains all of the data and software required to enable function as a calendar server. Calendar server 122 keeps track of all of the calendar-based projects originated using desktop interface applications like MS outlook™, or other programs that enable scheduling and notification of planned repetitive projects like sales meeting, board meetings, work projects, and so on. Enterprise collaboration server 121 includes a non-transitory physical medium that contains all of the data and software required to enable function as a collaboration server. Collaboration server 121 hosts collaborative software applications used to collaborate on projects such as whiteboard applications, document sharing and syncing, and other like collaborative tasks. Collaboration server 121 includes a data repository 124 adapted to hold all of the documents and any versions or revisions thereof that are subject to collaborative exercises held within the enterprise domain.

It is noted herein that participants in collaborative communications and communications in general need not be stationed within the domain of the enterprise. For example, server 121 may host a collaborative meeting where many of the participants are outside of the physical domain of the enterprise, like home-based workers, personnel stationed at other enterprises, etc. These collaborators use the external carrier networks including the Internet network to connect to server 121 to access a particular collaborative project, or to engage in project-related workflow. Likewise, there are no domain restrictions on participants in email collaboration or participation in calendar-based work project interaction.

LAN 104 supports an interaction server 105. Interaction server 105 includes a non-transitory physical medium that contains all of the data and software required to enable function as an interaction server. Server 105 executes a software application 113. Software application 113 is adapted to track all current ongoing work projects related to personnel working within the enterprise and those participating from external locations. SW 113 has capability of uniquely identifying ongoing projects subject to collaborative working environments and for analyzing and associating interactions that occurred outside of the host-domain of the identified projects to the correct project to which those interactions relate. Such interactions may include, but are not limited to emails, text messages, phone calls, voice interactions, schedule changes, meeting notes, and the like.

Server 105 includes a data repository 112 for storing all of the interaction records and results thereof that can be attributed to an ongoing work project or collaborative effort ongoing within the enterprise domain. Interaction records within repository 112 are accessible by search and query, and can be accessed and served to any authorized project manger or host that requests the information. In use of the present invention, a person operating from any of the LAN-connected sites may create a project that requires periodic collaboration, like a re-occurring meeting, a goal-oriented project with repeat evaluation or report meetings, or any other type of project where follow-up group interaction is required to manage or complete such a project.

In one embodiment, such a project with periodic or ongoing participation and management requirements may be created initially using an application accessible from a desktop computer such as any of applications 118-120 running on PCs 109-111 respectively. For example, application 118 may be a Microsoft Outlook™ project scheduler that is supported by calendar server 123 for scheduling and notification purposes. Other applications that might be used and supported include meeting applications like SalesForce™, collaborative interfaces like GoToMeeting™, and others. As soon as a user creates a re-occurring calendar event that includes a schedule, calendar server 123 sends a notification of the new event, termed an interaction event, to interaction server 105.

Once server 105 has the new event it creates an entity object, also termed a conversation entity object, representing the new event, and assigns a unique identification to the entity object for tracking and association purposes. The event entity object may include all of the metadata associated with the event when the event was created such as event title, event purpose, any descriptive keywords that were generated and related to the event, contact information of event participators and so on. In one embodiment, if notification has not been sent out to all event invitees using calendar server 123, server 105 may send notification after registering the re-occurring event.

In another embodiment the re-occurring event might be a collaborative project created using a desktop collaboration interface supported by collaboration server 121. Such an application may reside on PC 111 as application 120, for example. Once the collaboration server has created the event, it notifies interaction server 105 of the event and forwards the event and all relevant metadata to interaction server 105. Interaction server 105 then creates an event entity representing the re-occurring event and assigns a unique identifier to that entity.

Server 105, aided by SW 113, further creates entity instance objects, also termed conversation entity objects, that are attributes of the recorded object entities that depend from them as child objects, those entity objects intended to represent periodic collaborations or scheduled sessions held under the auspices of the identified parent interaction event. In this regard, each ongoing interaction event model or object is further constructed through the addition of instance entities or attributes (conversation instance entities) representing single scheduled or non-scheduled collaborations or discussions that are related to the parent object. Such interaction events may include, for example, the first scheduled meeting, conference, or collaborations hosted under an event. These instance entities are associated with their parent entity object by title and descriptive keywords, abstracts, phrases, or other identification methods such as identification number tagging.

In the course of project participation, there will be interactions between participants that are related to an instance entity, an attribute of the interaction event object that may occur outside of the domain of the collaborative software, meeting room, or conference room. Such interactions may include phone calls or notifications, email or message exchanges, propagated notes or artifacts, or further revisions to an artifact like a document. Server 105 has the capability of intercepting these single and unscheduled interactions and determining if those interactions might relate to an identified re-occurring interaction event or to any particular instance entity related to that event. An instance entity typically defines a re-occurring meeting, collaborative session, decision conference, or other like events having multiple participants. Interactions that are found to relate to such instance entities may be made part of that entity for search and archiving purposes.

In one embodiment, server 105, executing SW 113, can intercept ongoing communications occurring in real time within the enterprise and may determine without previous identification, if the communications should be part of an existing event instance entity by matching descriptors associated with the communication to descriptors associated with the instance entity object. Another capability of server 105 is data mining recorded interaction records to determine if there are any such records that should be part of an ongoing project instance entity. For example, an impromptu phone session held between two project participants, where one is located externally from the enterprise and the other located within the enterprise, might be identified by title, subject matter, or other descriptors, including participant names and titles, to a particular instance entity attributed to an ongoing interaction event represented by an event entity object.

All archives, interaction records, documents, presentations, and so on that are identified as associated to a recorded instance entity are linked to that instance entity. In turn, each instance entity that is an attribute of an interaction event object is linked to the parent object. Each instance entity established under a parent event entity may be hierarchically associated to the parent object by date of occurrence, included content, revision level, and so on. In this way a desktop search interface might be used by an authorized person to browse projects and drill down to latest revision documents, email exchanges, telephone records, and any other associated exchange that may have occurred under the auspices of a main interaction event. All management and tracking of event-relative data is automated in this example. However, in some cases, some manual work might be performed on the aggregated data for various purposes, such as new event association purposes, correction purposes, training purposes, statistics development purposes, marketing purposes, and so on.

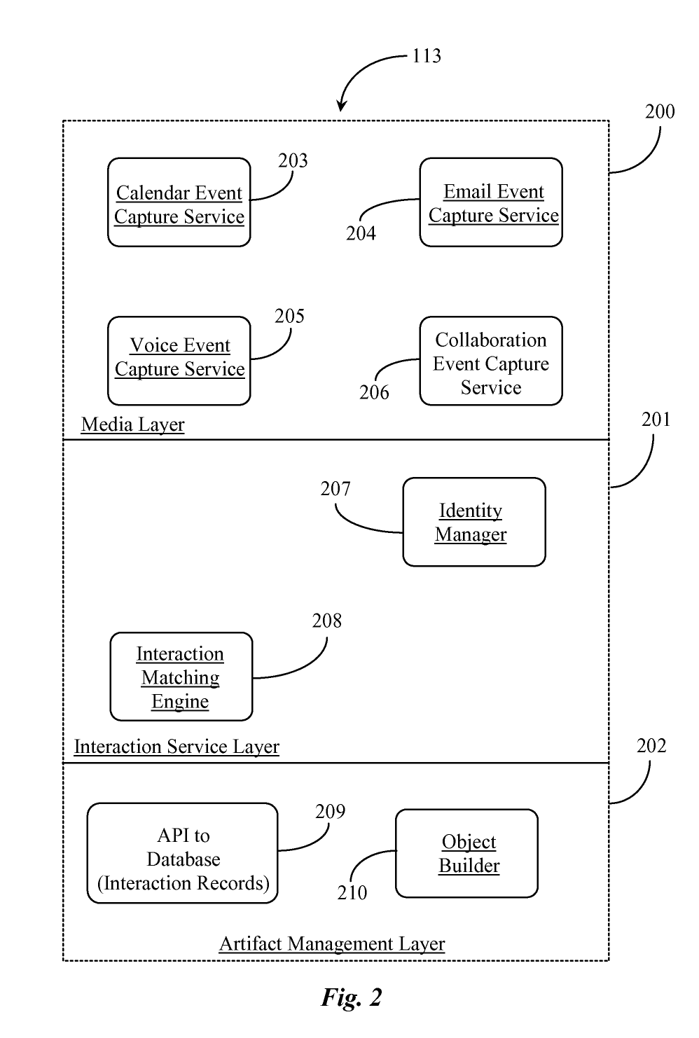

FIG. 2 is a block diagram illustrating basic components of SW 113 of FIG. 1. Software 113 includes a media layer 200, an interaction service layer 201, and an artifact management layer 202. Media layer 200 is adapted to enable media capture services related to a variety of types of media communication that may occur relative to ongoing or re-occurring events that are managed at the server. A calendar event capture service 203 is provided and adapted to receive a user-initiated calendar-based event. The user simply creates the event using a desktop interface and then uploads the event and related data to a calendar server such as calendar server 123 (FIG. 1). Calendar server 123 (FIG. 1) may push the event to the interaction server 105 (FIG. 1) or the interaction server my monitor and pull the event as soon as it is uploaded and scheduled.

The calendar-based event is forwarded to the interaction service layer where an identity manager 207 provides a unique identifier to the event. The identifier may be a randomly generated tag or number. Once the event is identified, the event data may be passed to the artifact management layer 202. An object builder 210 may be utilized to build an object in the server representing the identified event. The object built will have the unique identifier.

In addition to generating the object entity representing the newly received event, the object builder also creates an instance of the object meant to represent an instance of collaboration or a meeting, or a scheduled conference that is held under the auspices of the main object. The object container will be populated when a new event instance is held and all associated recordable communications that transpired during and around the instance event will be linked to the event.

Media layer 200 includes an email event capture service 204. Given a registered interaction event and linked instance entity container, email event capture service 204 is adapted to intercept email messages and parse them for data that relates the emails to one or more registered instance entity objects. An email chain used in collaborative discussion might be a candidate for interception and analysis. An interaction-matching engine 208 within interaction service layer 201 may perform the analysis. Interaction-matching engine 208 may use subject line, participant identifiers including cc and bcc email addresses, and parsed subject matter contained within the message bodies to determine if the chain should be part of a re-occurring interaction event, more particularly, be classed as a new object instance entity.

A collaboration event capture service 206 is provided within media layer 200 and is adapted to intercept a scheduled or un-scheduled collaboration event such as one hosted by collaboration server 121 (FIG. 1). In one embodiment, a user may create a re-occurring interaction event that uses one or more collaboration tools to meet and discuss a project using a desktop interface like interface 120 running on PC 111 (FIG. 1). Collaboration server 121 may push the created event to interaction server 105. Calendar event capture service 203 in media layer 200 or collaboration event capture service 206 might be used to aggregate the event data and forward it to identity manger 207 for identification assignment and then to object builder 210 to create the re-occurring event. Subsequent collaboration events detected within the system may then be intercepted by service 206 and passed to the interaction-matching engine 208 whereby they may be associated with a correct event instance entity. A weekly whiteboard sales meeting may qualify as a collaboration instance entity linked to a parent collaboration interaction event registered with the server.

Once the re-occurring events are established as system objects including at least a container for subsequent instances (meetings) related to the event, loose and informal interactions might be captured in the same way as re-occurring instances and associated under the proper interaction event. In one example of this, consider a regularly scheduled collaboration session of 10 participants registered under a main entity object as an instance entity of the object. Subsequently (after the session terminates), two of the original participants engage in an impromptu telephone session about the project meeting. The voice event capture service 205 may intercept the session in real time or after the fact and analyze it for possible relation to an instance entity already recorded in the system. Interaction-matching engine 208 analyses the telephone session to determine if there is sufficient descriptor or keyword match to an instance entity. If so, the session is archived under the matching instance entity under the interaction event object.

Artifact management layer 202 includes an application program interface (API) to an interaction record database (112, FIG. 1). Any captured interactions of any media sort may be analyzed and matched to an instance entity. Those that provide significant relevancy according to interaction-matching procedures are archived in the interaction database and are rendered searchable by descriptor, keyword, or identifier of the parent interaction event. In this way loosely associated conversations and discussions that would otherwise not be included in the project records could be captured and incorporated in the appropriate vein (instance entity) of the project.

In one embodiment, all side discussions or conversations where it is not meant that other project participants have access to could be encrypted by the authors or by the interaction management engine if indicated so that only authorized personnel may open it and disseminate the materials. In one embodiment, members of a group conducting regular group collaborations may have selective access to certain event instance entities or portions thereof while others may have full access to all related materials.

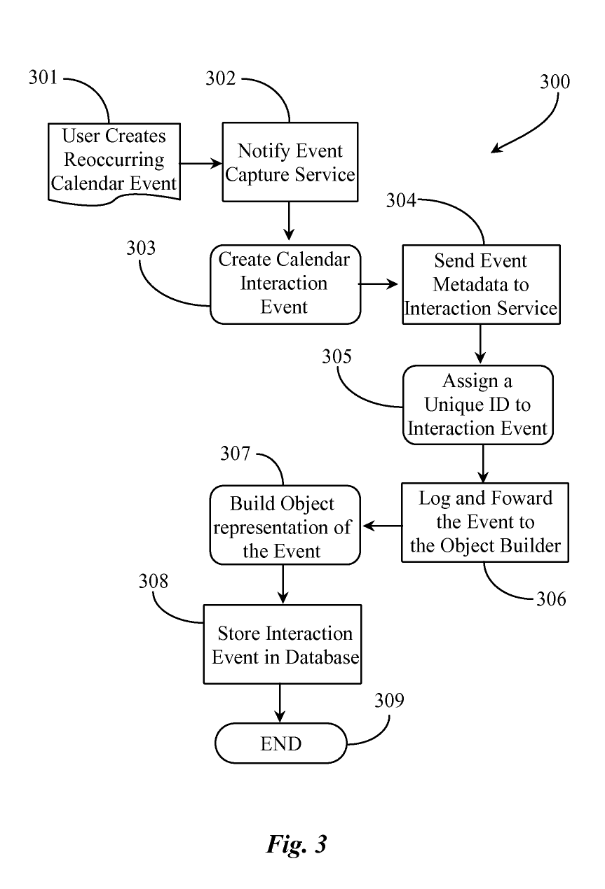

FIG. 3 is a process flow chart 300 illustrating steps for creating a reoccurring event in object representation format according to an embodiment of the present invention. At step 301, a user creates a re-occurring calendar event. This may be accomplished using a desktop or remote desktop interface as described further above so long as server connectivity is established for uploading purposes. The calendar event server 123 (FIG. 1) notifies the capture event service (203, FIG. 2) of the newly created event at step 302. All of the data and metadata associated with the new event are incorporated into a calendar-based interaction event, which is then forwarded to the interaction service at step 304. The event may be characterized by different event sections specifying certain data sets and may be represented by a machine-readable markup language like extensible markup language (XML) or some other machine-readable markup.

The identity manager (207, FIG. 2) assigns a unique identification to the received interaction event at step 305. The identifier is unique from all other identifiers assigned to events in the system. It may be a randomly generated or a serially issued identifier. At step 306, the event is registered, logged and forwarded to the conversation management object builder at step 306. The object builder generates a main event object and an event instance object at step 307. The object instance is intended to represent subsequent scheduled and, in some cases non-scheduled, instances of group interaction that will occur under the main event. The event object and the object instance container may be rendered executable for search and data mining purposes. The object instance container need be generated only once and can be copied or spawned in native form absent of any data stored in the previous instance.

At step 308, the populated object representing the main event is stored in a server database for future reference and access. The process then ends at step 309.

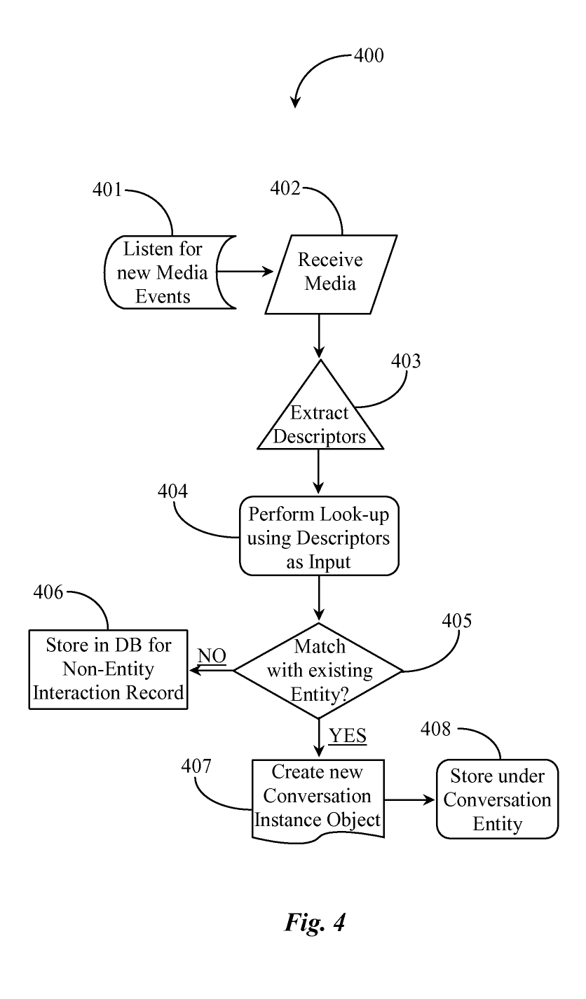

FIG. 4 is a process flow chart 400 illustrating steps for intercepting incoming or outgoing media events and matching those events with appropriate conversation entities according to an embodiment of the present invention. Process flow 400 assumes that a re-occurring conversation entity object is registered in the interaction server. At step 401, the interaction service listens for any new media events or communications. In this case, some events will be scheduled events such as a first general meeting under a registered conversation entity object. With scheduled meetings like sales meetings, lectures, planning meetings, etc.

The capture services may actively monitor for events during the expected start time for those events. The capture service may also intercept events that are not relevant to any registered conversation entity object. It is noted herein that the various capture services in media layer 200 (FIG. 2), may work together in concert for session using more than one media type. At step 402, the capture services in the media layer receive the targeted media records. At step 403, the data is parsed for keywords and descriptors, which are extracted for use as search and match criteria. A session that qualifies for capture may be a multi-party collaborative meeting intended as a regular meeting under the main conversation entity (re-occurring interaction event), a side conversation not directly related to a main re-occurring event, or even a single discussion or notification made that could potentially be related to a main conversation entity, more particularly a conversation instance entity that is child to a main interaction event object.

At step 404, the interaction-matching engine (208, FIG. 2) performs a database lookup utilizing the main descriptors and keywords contained in the received media records. These descriptors may include subject lines, titles, participant identities, and content-based keywords. Voice, video, and text content may all be subject to interaction-matching criteria. The interaction-matching engine attempts to match the current media record or records to an existing conversation entity by related content. At step 405, it is determined if a sufficient match has been made to an existing object entity.

If at step 405, a sufficient match has been made, then at step 407, the object builder may create a new conversation instance entity object under the existing conversation entity. The instance becomes an attribute of the parent entity and all of the content associated with the instance is rendered searchable. The conversation instance entity may be assigned the same identifier as the parent entity with a sub-identifier to differentiate it from future conversation instance entities recorded that match the same entity. The newly created instance object is stored as an attribute of the main conversation entity object at step 408.

If at step 405, the interaction-matching engine could not create a sufficient match, the process may resolve to step 406 where the interaction data and media is stored in a regular database for interaction records that are not specifically part of any ongoing project occurring within the enterprise system. However, the media capture services may also pull interaction records from any accessible data storage source and review them to determine if any records should be attributed to a conversation instance or a conversation entity as a conversation instance as will be described further below.

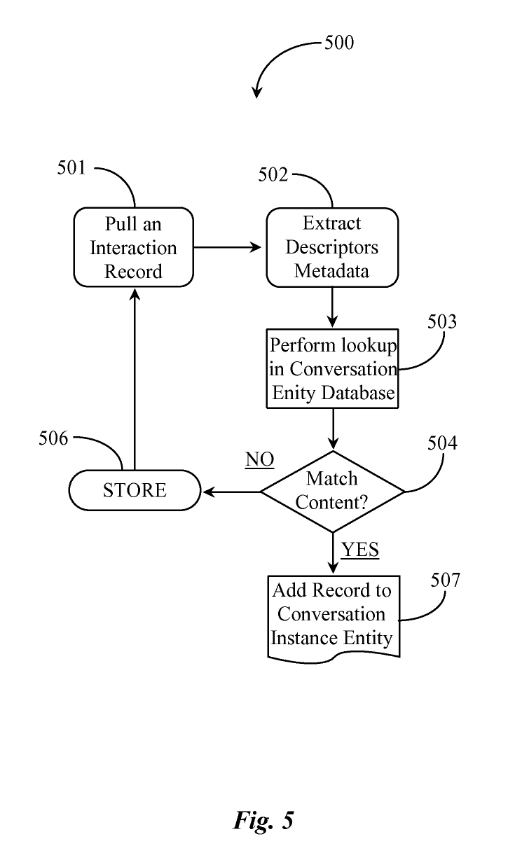

FIG. 5 is a process flow chart 500 illustrating steps for pulling interaction records for the purposes of matching them to an appropriate conversation entity according to an embodiment of the present invention. At step 501, the interaction-matching engine, in concert with any of the media capture services described above, pulls an interaction record from the general interaction database for review. It is assumed in this example that conversation entities and child conversation instance objects to those entities exist in the interaction server “conversation” database for comparison.

At step 502, the interaction-matching engine extracts the descriptors, keywords and metadata for use as search criteria. At step 503, the interaction-matching engine performs a lookup in the conversation database to determine if the interaction record matches any existing conversation instance entities or conversation entities using descriptors found in the record, matching them against descriptors on file and associated with the entities.

At step 504, the interaction-matching engine determines if it has achieved a match relative to a current interaction record. The interaction record may consist of a single interaction like an email and an email reply, or a threaded interaction like an email chain or a chat transcript. Recorded phone calls or voice interaction records may include multi-party records like a conference call record or a single telephone call record. In one embodiment requests for interaction that were not completed may also be found to belong to a conversation instance entity as a record of attempted contact that should be followed up.

If at step 504, the interaction-matching engine finds a match, the engine may add the interaction record to the conversation instance entity it matches at step 507. After adding the record and content, the interaction record is rendered searchable and can be retrieved by a person using a search engine or by browsing the conversation object and expanding the details through the attributes. In one embodiment of the present invention data plays a crucial role in helping to match records. For example, a single date interaction record may cause the engine to lookup conversation instance entities closer to that record date first making the look-up operation more efficient.

Timestamps may also be used to help correlate interaction records to match against a conversation instance entity sharing the same or similar time and date. However, loose interaction records may or may not have similar date and time parameters as a conversation instance it might be matched to. If at step 504, the interaction-matching engine cannot find a match for the pulled record, it may re-store the record and move to the next interaction record for analysis. In one embodiment, a side step of process 500 may prompt a creator of a re-occurring interaction event if a new event should be created or if an existing event could be canceled if it is no longer an open project.

It will be apparent to one with skill in the art that the interaction management system of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

What is claimed is:

1. A system for managing interactions within an enterprise, comprising:
a network-connected server; and
software executing on the server from a non-transitory physical medium, the software providing:
a first function for establishing a recorded instantiation of a re-occurring event and assigning a unique identifier to that event;
a second function for creating an abstract conversation entity object representing the reoccurring event and for creating an executable conversation instance entity object to represent specific meetings or collaboration events under the reoccurring event;
a third function for matching any incoming or outgoing interactions or interaction requests that occur within the enterprise domain to the conversation instance entity tied to the conversation entity; and
a fourth function for managing and archiving the interaction records and results thereof as searchable interaction records tied to the conversation instance entity.

2. The system of claim 1, wherein the network is one of a local area network or a wide area network connected to the Internet network.

3. The system of claim 1, wherein the network is the Internet network.

4. The system of claim 1, wherein the interactions include messages and message chains, voice interactions, video interactions, presentations, documents, and notes.

5. The system of claim 1, wherein the reoccurring event is a physical meeting of live persons or a virtual meeting of live persons detected by virtual presence.

6. The system of claim 1, wherein the reoccurring event is generated by a calendar-based application.

7. The system of claim 6, wherein the calendar-based application is a meeting and appointment scheduling application or a conference scheduling application.

8. The system of claim 6, wherein the calendar-based application is a collaboration scheduling application.

9. The system of claim 1, wherein the conversation instance entity object is an attribute of the conversation entity object, the conversation instance entity object related to the conversation entity object by description including keywords and or a unique identifier.

10. The system of claim 1, wherein the interactions are identified as associated to a conversation entity instance object by matching description including keyword criteria.

11. The system of claim 1, wherein the interaction records are searchable via a search engine interface by entering keywords attributed to the conversation instance entity, the conversation entity, or the reoccurring event.

12. The system of claim 1, wherein the conversation entity is assigned the same identification number as the reoccurring event and wherein the child conversation instance entities are assigned generated variants of the assigned identifier.

13. A method for tracking and managing interactions and results thereof related to a reoccurring event generated within an enterprise domain, comprising steps of:
(a) establishing a recorded instantiation of the reoccurring event and assigning a unique identifier to that event;
(b) creating an abstract conversation entity object representing the reoccurring event and an executable conversation instance entity object to represent specific meetings or collaboration events scheduled under the reoccurring event;
(c) matching any incoming or outgoing interactions or interaction requests that materialize within the enterprise domain to the conversation instance entity tied to the conversation entity; and
(d) managing and archiving the interaction records and results thereof as searchable interaction records tied to the conversation instance entity.

14. The method of claim 13, wherein the interactions include messages and message chains, voice interactions, video interactions, presentations, documents, and notes.

15. The method of claim 13 wherein, in step (a), the reoccurring event is a physical meeting of live persons or a virtual meeting of live persons detected by virtual presence.

16. The method of claim 15, wherein the reoccurring event is generated by a calendar-based application.

17. The method of claim 16, wherein the calendar-based application is a meeting and appointment scheduling application or a conference scheduling application.

18. The method of claim 16, wherein the calendar-based application is a collaboration scheduling application.

19. The method of claim 13, wherein in step (b), wherein the conversation instance entity object is an attribute of the conversation entity object, the conversation instance entity object related to the conversation entity object by description including keywords and or a unique identifier.

20. The method of claim 13, wherein in step (c), the interactions are identified as associated to a conversation entity instance object by matching description including keyword criteria.
